(19) United States
(12) Patent Application Publication
(10) Pub. No.: US 2005/0288469 A1
(43) Pub. Date: Dec. 29, 2005

(54) Methacrylic resin molded article having surface fine structure and production process thereof

(76) Inventors: Masahiro Higuchi, Gifu-ken (JP); Yoshiaki Maeno, Mizuho-shi (JP); Kazuaki Someya, Gifu-ken (JP); Yoshihide Amekawa, Niihama-shi (JP); Nissho Iwamoto, Yao-shi (JP)

Correspondence Address: ARENT FOX PLLC, 1050 CONNECTICUT AVENUE, N.W., SUITE 400, WASHINGTON, DC, 20036, US

(21) Appl. No.: 11/143,961

(22) Filed: Jun. 3, 2005

(30) Foreign Application Priority Data
Jun. 4, 2004 (JP) 2004-167208

(51) Int. Cl. G01J 3/00

(52) U.S. Cl. 526/319

(57) ABSTRACT

A process for producing a methacrylic resin molded article having a surface fine structure with a high aspect ratio. The method includes injecting a composition into a cell or cavity provided with a negative pattern corresponding to the surface fine structure, and solidifying the composition in the cell or cavity by polymerization. The composition contains components A, B, and C. A: an unsaturated monomer mixture, which includes 20 to 90% by weight of an unsaturated monomer including methylmethacrylate as a major component, and 10 to 80% by weight of an unsaturated monomer having at least two polymerizable double bonds in one molecule; B: a polymer of an unsaturated monomer including methylmethacrylate as a major component, which polymer includes 20 to 100% by weight of partially crosslinked polymer particles and 0 to 80% by weight of non-crosslinked polymer particles; and C: a polymerization initiator.

### CROSS-REFERENCE TO RELATED APPLICATIONS

This application is based upon and claims the benefit of priority from prior Japanese Patent Application No. 2004-167208, filed on Jun. 4, 2004, the entire contents of which are incorporated herein by reference.

### BACKGROUND OF THE INVENTION

The present invention relates to a methacrylic resin molded article having a surface fine structure for realizing a desired optical property, such as antireflection, polarization split or the like, and to a production process thereof.

Conventionally, optical elements having antireflection (AR) functions have been used for electronic displays, and optical elements having polarization split function have been used for optical pick-up devices, which record information on an optical disk or regenerate information recorded on the optical disk. Japanese Laid-open Patent Publication Nos. 11-312330 and 2000-76685 describe conventional optical elements having a multi-layer film structure including plural films are laminated on a substrate.

In general, multi-layer films in a multi-layer film structure have refractive indexes different from each other. Desired optical functions, such as AR function or polarization split function, can be obtained by the comprehensive optical properties of multi-layer films.

The AR function is a function capable of suppressing the reflection or scattering of incident light and enhancing the transmittance of an optical element. For example, when light from the outside (incident light) reflects or scatters on the display surface of a mobile phone or computer, a phenomenon of lowering visibility, that is, reflection, occurs. Accordingly, in displays, it is general to lower the reflectance on the display surface and thereby to avoid the reflection or diffusion of incident light.

The polarization split function is a function of separating P polarized light from S polarized light, which have planes of polarization orthogonal to each other, by permitting only one polarized light be transmitted through the optical element among P polarized light and S polarized light and reflecting the other polarized light.

Even in optical elements having a multi-layer film structure such as optical filters, phase difference plates or the like, utilizing the comprehensive optical properties of the multi-layer film, the desired optical properties can be realized.

In a conventional optical element having a multi-layer film structure, the desired optical property can be obtained by adjusting the thickness of each film constituting the multi-layer film structure. However, it is difficult to appropriately adjust the thickness of each film. Irregularities may be caused in the refractive index depending upon film forming conditions. Accordingly, the desired optical property may not be always obtained. Additionally, the film materials for forming the multi-layer films are limited and the design of optical elements has a low degree of freedom.

Recently, it has become available to conduct fine processing or fine molding with a precision of the wavelength or lower of light, namely submicron order by the progress of semiconductor processing technique or electronic beam processing technique. It is available to form various fine structures or fine patterns for imparting various optical properties on the surface of an optical element (substrate) by fine processing. Under circumstances, at present, the following method is proposed. A substrate having a fine structure or fine pattern formed thereon is used as a master. A mold (template) is prepared by an electrocasting (electroforming) method. Transparent plastic optical elements are mass-produced at a low cost by injection molding or compression molding with this mold. Japanese Laid-open Patent Publication No. 2001-201746 proposes a method of mounting a mold formed with a fine structure on a pressing machine, contact bonding the mold into a transparent plastic flat plate and thereby transferring the fine structure or fine pattern on the transparent plastic flat plate.

For attaining the desired optical property, it is necessary to form a fine structure or fine pattern each having a high aspect ratio, namely to form the fine structure or fine pattern more deeply than the depth of its repeating pitch. However, it is technically difficult to form a fine structure having a high aspect ratio with submicron order by a conventional injection molding or compression molding. In the conventional method as described in Japanese Laid-open Patent Publication No. 2001-201746 described above, the height of each projection provided on the mold is 0.9 μm, while the height of the projection transferred on the flat plate (depth of recess) is 0.8 μm. In this case, the pattern transfer fidelity (pattern transfer accuracy) is only 88.9%. A conventional fine processing to form submicron order structure may further lower the pattern transfer fidelity. The present inventors examined and confirmed that when a fine structure with submicron order is transferred by a conventional molding method, pattern transfer fidelity of injection molding is fall within a range about 70 to 80%, pattern transfer fidelity of compression molding is fall within a range about 80 to 90%.

### SUMMARY OF THE INVENTION

It is an object of the invention to provide a methacrylic resin molded article having a surface fine structure with high accuracy and having excellent mass productivity, and to provide a process for producing the molded article.

According to a first aspect of the present invention there is provided a methacrylic resin molded article having a surface fine structure. The surface fine structure is formed by polymerizing a composition in a cell or cavity having an inner surface with a negative pattern corresponding to the surface fine structure subsequent to introducing the composition into the cell or cavity. The composition contains the following components A, B, and C:
(A) 30 to 60 parts by weight of an unsaturated monomer mixture, which mixture contains 20 to 90% by weight of an unsaturated monomer including methylmethacrylate as a major component, and 10 to 80% by weight of an unsaturated monomer having at least two polymerizable double bonds in one molecule;
(B) 40 to 70 parts by weight of particles made of a polymer of an unsaturated monomer including methylmethacrylate as a major component, which particles include 20 to 100% by weight of partially crosslinked polymer particles and 0 to 80% by weight of non-crosslinked polymer particles; and
(C) 0.1 to 5 parts by weight of a polymerization initiator per 100 parts by weight of the total of the above components A and B.

A further aspect of the present invention is a process for producing a methacrylic resin molded article having a surface fine structure. The process includes introducing a composition to a cell or cavity having an inner surface with a negative pattern corresponding to the surface fine structure, and polymerizing the composition in the cell or cavity. The composition contains the following components A, B, and C:
(A) 30 to 60 parts by weight of an unsaturated monomer mixture, which mixture contains 20 to 90% by weight of an unsaturated monomer including methylmethacrylate as a major component, and 10 to 80% by weight of an unsaturated monomer having at least two polymerizable double bonds in one molecule;
(B) 40 to 70 parts by weight of particles made of a polymer of an unsaturated monomer including methylmethacrylate as a major component, which particles include 20 to 100% by weight of partially crosslinked polymer particles and 0 to 80% by weight of non-crosslinked polymer particles; and
(C) 0.1 to 5 parts by weight of a polymerization initiator per 100 parts by weight of the total of the above components A and B.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIGS. 1A to 1D are schematic cross-sectional views showing a process for producing a master used in producing a methacrylic resin molded article according to the first embodiment of the present invention.

FIGS. 2A to 2C are schematic cross-sectional views showing a process for producing a master and FIG. 2D is a schematic perspective view of the master.

FIG. 3 is a schematic diagram showing a process for forming a mold using a master.

FIG. 4 is a perspective view showing a process for forming a cell.

FIG. 5 is a perspective view showing a process for forming a cell.

FIG. 6 is a perspective view showing a process for forming a cell.

FIG. 7 is a plane view of FIG. 6.

FIG. 8 is a perspective view showing a process for forming a cell.

FIG. 9 is a cross-sectional view of the cell taken along the line 9-9 in FIG. 8.

FIG. 10 is a perspective view showing a process for injecting a monomer mixture.

FIG. 11 is a perspective view showing a process for polymerization of a monomer mixture.

FIG. 12 is a perspective view showing a process for taking out a methacrylic resin molded article from a cell.

FIG. 13 is a schematic perspective view of a methacrylic resin molded article of the first embodiment of the present invention.

FIG. 14 is a sectional view of the molded article taken along the line 14-14 in FIG. 13.

FIG. 15 is a graph showing a relation of the reflectance and the wavelength with regard to a methacrylic resin molded article of the first embodiment and a conventional optical element having a multi-layer antireflective film.

FIG. 16 is a schematic diagram showing a process for producing a methacrylic resin molded article according to the second embodiment of the present invention.

FIG. 17 is a sectional view of a cell of the second embodiment according to the present invention.

FIG. 18 is a sectional view showing a modification example of a cell.

FIG. 19 is a perspective view showing a modification example of a large size cell.

FIG. 20 is a schematic diagram showing a continuous casting apparatus for carrying out cast polymerization.

FIG. 21A is a partial side view of a master of the modification example.

FIG. 21B is a partial perspective view of a master of the modification example.

FIG. 22 is a process for forming a mold with casting using the master of FIG. 21A.

FIG. 23 is a cross-sectional view of a molded article formed using the mold of FIG. 22.

FIG. 24 shows a container storing a resin composition.

FIGS. 25A to 25C show a compression molding process of a semisolid casting material.

FIGS. 26A and 26B show an injection molding process of a semisolid casting material.

### DETAILED DESCRIPTION OF THE PREFERRED EMBODIMENTS

A methacrylic resin molded article according to the first embodiment of the present invention and the production process thereof will now be described.

The methacrylic resin molded article according to the first embodiment has a surface having a fine structure formed with very high accuracy, for changing the effective refractive index of the resin molded article. The fine structure of the surface provides the molded article with high AR (antireflection or non-reflection) function.

The process for producing the molded article will be described below.

The process for producing the molded article according to the first embodiment includes the following major five steps. In the first embodiment, batch casting method is employed, in which casting is repeatedly carried out in at least one cell defined by two or more flat plates arranged in parallel to each other.

Step 1: a cell 27 (FIG. 9) having a cavity 26 is formed. The cell 27 has at least one inner surface provided with a negative (reversal) pattern corresponding to the desired surface fine structure.

Step 2: a resin composition (fluid or syrup) M containing components A, B and C is injected into the cell 27 (FIG. 10).

Component A: 30 to 60 parts by weight of an unsaturated monomer mixture. The mixture contains an unsaturated monomer A1 comprising methylmethacrylate as a major component and an unsaturated monomer A2 having at least two polymerizable double bonds in one molecule. In the specification, the unsaturated monomer A2 may also be referred to as a polyfunctional unsaturated monomer. The component A contains 20 to 90% by weight of the monomer A1 and 10 to 80% by weight of the monomer A2.

Component B: 40 to 70 parts by weight of polymer particles of unsaturated monomers. The unsaturated monomers include methylmethacrylate as a major component. The particles include 20 to 100% by weight of partially crosslinked polymer particles and 0 to 80% by weight of non-crosslinked polymer particles.

Component C: a radical polymerization initiator. The amount of the radical polymerization initiator is adjusted to 0.1 to 5 parts by weight per 100 parts by weight of the total of the components A and B.

Step 3: the injected resin composition M is stored (matured) in the cell 27 for a while to promote mixing of the resin composition.

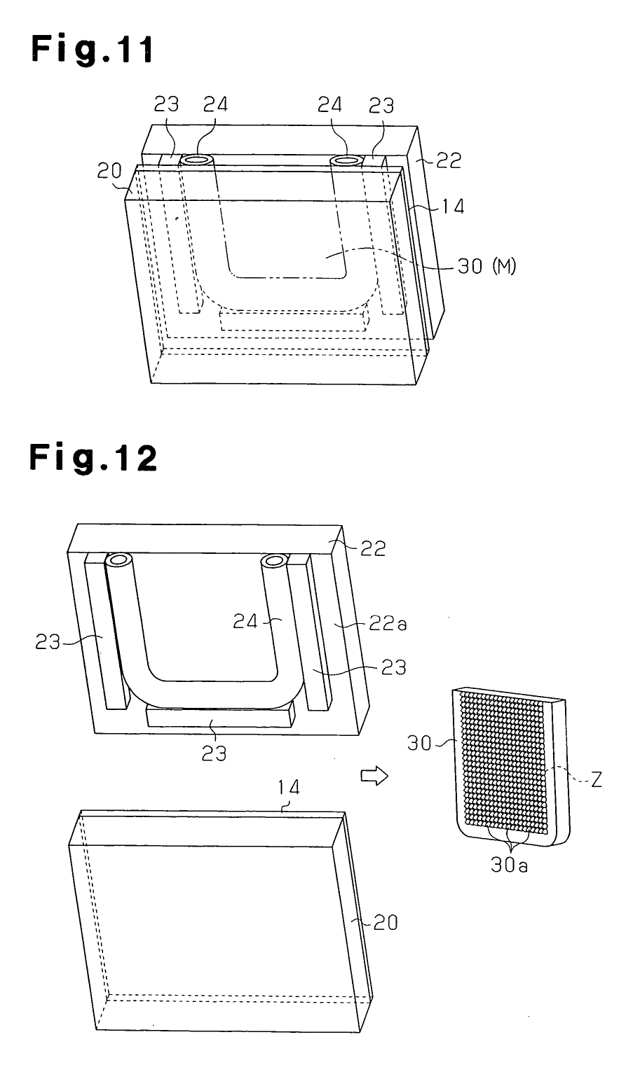

Step 4: the resin composition M is subjected to polymerization reaction in the cell 27 (FIG. 11). The resin composition M is solidified by the polymerization reaction. By the solidification, a molded article is produced.

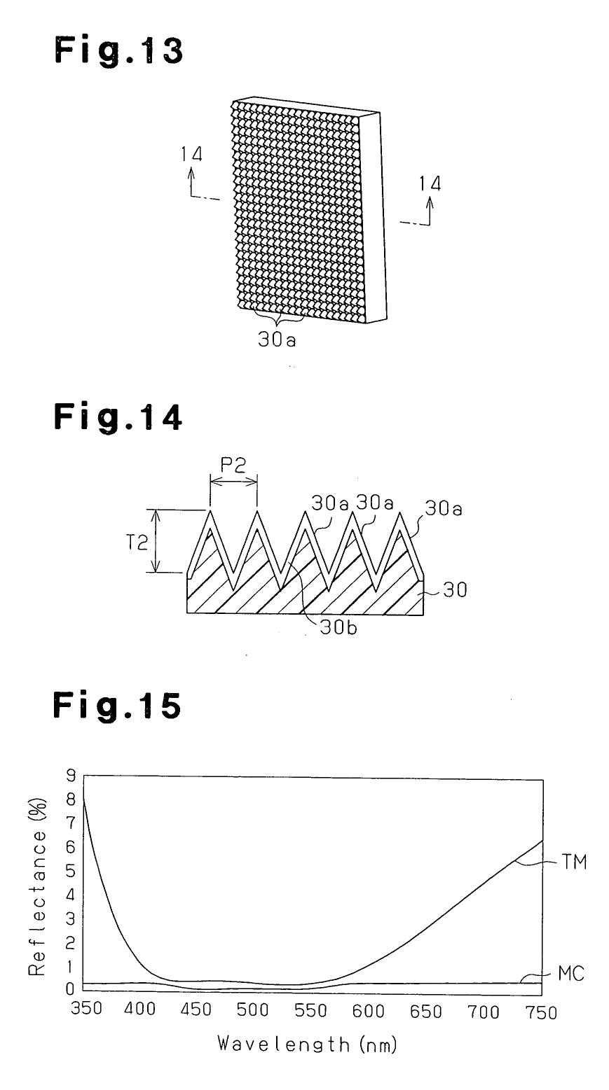

Step 5: the molded article is taken out from the cell 27. The molded article is cut out into the desired size, if necessary (FIG. 12 and FIG. 13).

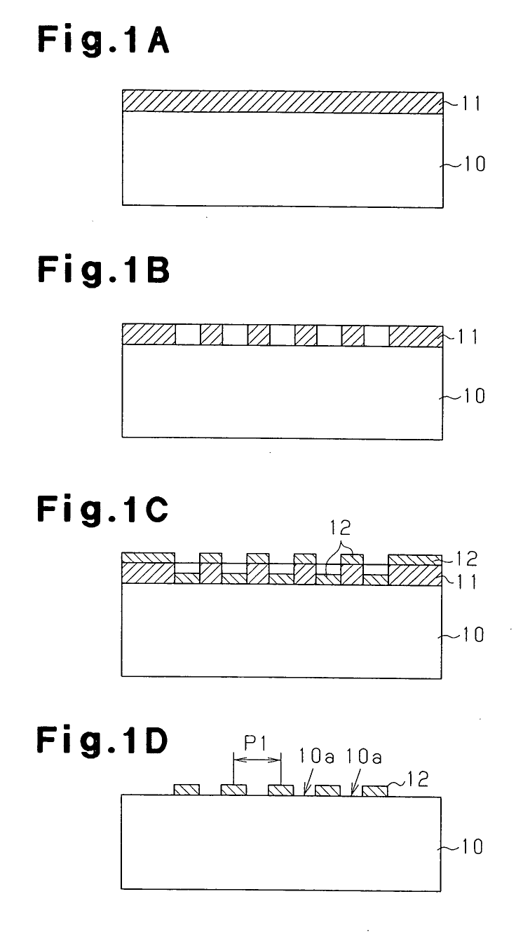

First, preliminary steps for producing a mold having a negative pattern, which step is carried out prior to the step 1, is described with reference to FIGS. 1 to 3. The preliminary steps include the following steps a1 and b1.

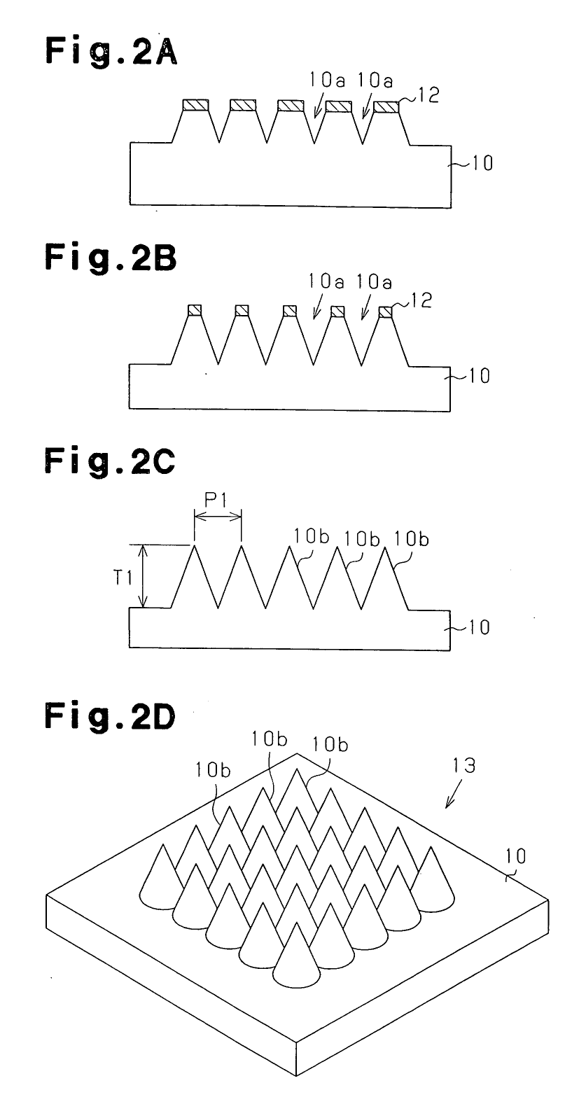

a1: a resist is applied on the surface of a substrate to draw and develop a pattern having a fine structure and then a proper mask is formed. A base material is etched using the mask to prepare a master (template) 13 having the above fine structure (FIG. 1 and FIG. 2).

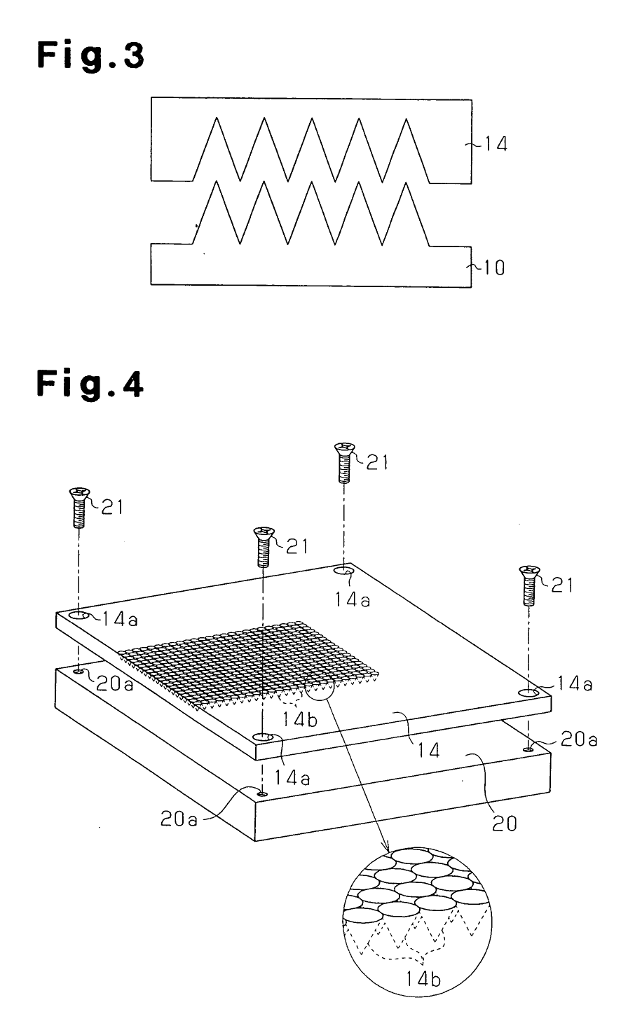

b1: using the master 13, a mold plate 14, which is used as a stamper mold for forming the fine structure, is produced by electrocasting (FIG. 3).

In the step a1, a resist 11 is applied on a substrate 10 composed of, for example, silicon (Si), quartz or the like, as shown in FIG. 1A. On the resist 11, a pattern having a fine structure is drawn by electronic beam drawing, two-luminous flux interference light exposure or the like, followed by developing, to form a resist pattern shown in FIG. 1B.

Next, as shown in FIG. 1C, vapor deposition of chromium (Cr) is carried out from the upper side of the resist pattern. Only a chromium film 12 is left by liftoff. Subsequently, the resist 11 is removed to form a chromium mask 12a on the substrate 10 as shown in FIG. 1D. The pattern of the mask 12a is a fine pattern with submicron order of not more than the wavelength of visible light. In one embodiment, the pattern of the mask 12a is a two-dimensional pattern (matrix-like pattern) having a repeating pitch P of from 250 nm to 300 nm when viewing from the upper surface.

Thereafter, the surface 10a of the substrate 10 is etched using the chromium mask 12a. In the first embodiment, the substrate 10 is etched by reactive ion etching with a reaction gas. As the reaction gas, it is possible to use a mixed gas of C₄F₈ and CH₂F₂ in the predetermined proportion, or CHF₃. In the case of using the mixed gas of C₄F₈ and CH₂F₂, the etching conditions are as follows.

| | | |
|---|---|---|
| Gas pressure | 0.5 | Pa |
| Antenna power | 1500 | W |
| Bias power | 450 | W |
| C₄F₈/CH₂F₂ | 16/14 | sccm |
| Etching time | 60 | sec |

The antenna power refers to a high frequency electric power to be applied on an antenna in an etching apparatus for plasma generation. The bias power refers to a high frequency electric power to be applied for drawing plasma onto the substrate 10. The mixing proportion of CH₂F₂ in the reaction gas is adjustable within the range of 10 to 50%. If the mixing proportion of CH₂F₂ is less than 10%, the angle of the recess formed by etching becomes too large and the aspect ratio of the projection is not more than 1.0. On the contrary, if the mixing proportion of CH₂F₂ is larger than 50%, the recess formed by etching becomes a U-shaped recess having a curved bottom surface.

FIGS. 2A to 2C show etching of the substrate 10 in a stepwise manner. With proceeding of the etching, not only the surface exposed from the chromium mask 12a but also the chromium mask 12a are gradually etched so that the diameter thereof is decreased. Finally, as shown in FIG. 2C, a surface fine structure having an antireflection function provided with conical projections (circular cone) 10b having a predetermined tip angle (taper angle) is formed on the surface of the substrate 10. In the first embodiment, the etching conditions including the mixing proportion of CH₂F₂ in the reaction gas are determined so that the height T1 of the projection 10b is from 300 to 500 nm. The pitch P1 of the projection 10b corresponds to the pitch P in FIG. 1D.

Through the above procedures, the master 13 having a surface fine structure as shown in FIG. 2D is produced.

Next, as shown in FIG. 3, the mold plate 14 is produced using the master 13 (step b1). The mold plate 14 is produced by, for example, an electrocasting process using nickel (Ni).

In the first embodiment, with respect to the master 13, a nickel (Ni) thin film is formed so as to have a film thickness of several hundred angstroms by a sputtering method to prepare a conductive film. Next, the conductive film composed of the nickel thin film is directly subjected to nickel electrocasting to laminate a nickel metal layer thereon. The metal layer laminated is released from the master 13 to acquire the mold plate 14.

By the electrocasting, the reversal structure (negative pattern) of the fine structure (fine pattern) of the master 13 is precisely transferred on the mold plate 14. In the following description, the negative pattern is sometimes called a reversal pattern.

As described above, prior to the step 1, the mold plate 14 having a negative pattern is produced and thereby the subsequent steps after the step 1 can be efficiently carried out.

Next, the step (step 1) for forming the cell 27 provided with a negative pattern is described with reference to FIG. 4 to FIG. 9.

In the first embodiment, the cell 27, in which the cavity 26 is defined by two mold parts (flat plates) 20 and 22 is formed. The flat plates 20, 22 are preferably made of a glass or metal material having a corrosion resistance to the resin composition M composed of methylmethacrylate as an essential ingredient. In the first embodiment, the thickness of each of the flat plates 20, 22 is approximately from 2.0 to 5.0 cm depending upon the thickness of the methacrylic resin molded article.

FIG. 4 is an exploded perspective view showing fixing the mold plate 14 to one of the two flat plates constituting the cell 27.

As shown in FIG. 4, the mold plate 14 is fixed to the first flat plate 20. The size of the first flat plate 20 is substantially the same as the size of the mold plate 14. On each angle of the flat plate 20, a screw hole 20a for fixing the mold plate 14 is formed. At each angle of the mold plate 14, an open hole (through hole) 14a corresponding to the screw hole 20a is formed. The mold plate 14 is mounted on the upper surface of the flat plate 20 so as to expose the surface on which the negative pattern (recess 14b) is formed and a screw 21 is put into the open hole 14a of the mold plate 14 and the corresponding screw hole 20a of the flat plate 20 to fix the mold plate 14 on the flat plate 20. By this fixing, the flat plate 20 integrally having a negative pattern is produced.

Thereafter, on the surface of the flat plate 20, exactly the surface on which the negative pattern (recess 14b) of the mold plate 14 is formed, a coating composition for forming a coat layer on the surface of the methacrylic resin molded article is applied (not shown). In the first embodiment, the major component (main ingredient) of this coating composition is a curable compound for protecting a surface fine structure. The curable compound is hardened by irradiation with rays such as ultraviolet rays or electron rays, or by heating with warm air, warm water or a heat source such as infrared heater or the like, to form a film having anti-scratching properties. Further, conductive fine particles capable of realizing antistatic properties, a solvent capable of adjusting the viscosity of the coating composition or an additive such as a curing catalyst or the like can be added to the curable compound.

Non-limiting examples of the curable compound may include acrylate, urethane acrylate, epoxy acrylate, carboxyl group-modified epoxy acrylate, polyester acrylate, copolymerization type acrylate, alicyclic epoxy resins, glycidyl ether epoxy resins, vinylether compounds and oxetane compounds. Among them, examples of the curable compound capable of imparting high anti-scratching properties to films may include radical polymerization type curable compounds such as polyfunctional acrylate compounds, polyfunctional urethane acrylate compounds, polyfunctional epoxy acrylate compounds or the like, and thermal polymerization type curable compounds such as alkoxysilane, alkylalkoxysilane or the like. These curable compounds may be used singly or in combination with the plural compounds.

Among the above curable compounds, preferable examples thereof are compounds having at least three (meth)acroyloxy groups in a molecule, for example, polymethacrylates of at least trivalent or polyvalent alcohol such as trimethylolpropane trimethacrylate, trimethylolethane trimethacrylate, glycerin trimethacrylate, pentaglycerol trimethacrylate, pentaerythritol tri- or tetra-methacrylate, dipentaerythritol tri-, tetra-, penta- or hexa-methacrylate and tripentaerythritol tetra-, penta-, hexa- or heptamethacrylate; urethane methacrylates having at least three (meth)acryloyloxy groups in one molecule obtainable by allowing a compound having at least two isocyanate groups on a molecule to react with a methacrylate monomer having a hydroxyl group in such a proportion that the hydroxyl group is in an amount equimolar or more based on isocyanate group (for example, reaction of diisocyanate and pentaerythritol trimethacrylate gives 3 to 6 functional urethane methacrylates); and trimethacrylate of tris(2-hydroxyethyl)isocyanuric acid.

As the curable compound, the above described monomers may be used as they are, or oligomers such as their dimer or trimer may be used, or the monomer and the oligomer may be used in combination.

The compounds having at least three (meth)acroyloxy groups are used in an amount of preferably not less than 50 parts by weight, more preferably not less than 60 parts by weight per 100 parts by weight of the solid components in the coating composition. When the content of the curable compounds having at least three (meth)acroyloxy groups is less than 50 parts by weight, the surface hardness is likely to be insufficient.

The term “(meth)” means “acryl” or “methacryl”.

Non-limiting examples of the conductive inorganic particles capable of imparting antistatic properties to films may include antimony doped tin oxide, phosphorus doped tin oxide, antimony oxide, zinc antimonate, titanium oxide, ITO (indium tin oxide) and the like. The particle diameter of the conductive inorganic particles, which can appropriately be determined depending upon the type of particle, is usually not more than 0.5 μm. From the viewpoint of the antistatic properties and transparency of a film having anti-scratching properties, the average particle diameter is preferably not less than 0.001 μm and not more than 0.1 μm. When the average particle diameter of the conductive inorganic particles is over 0.1 μm, the haze (degree of cloudiness) of a film having anti-scratching properties becomes larger and the transparency is likely to be lowered. Accordingly, the preferable average particle diameter is not less than 0.001 μm and not more than 0.05 μm. The conductive inorganic particles are used in an amount of usually about 2 to 50 parts by weight, preferably about 3 to 20 parts by weight per 100 parts by weight of the curable compound. When the amount of the conductive inorganic particles used is less than 2 parts by weight per 100 parts by weight of the curable compound, the effect of improving the antistatic properties is lowered, whereas when the amount thereof is over 50 parts by weight, the transparency of a cured film is likely to be lowered.

The conductive inorganic particles can be prepared by a known method, such as gas phase decomposition, plasma evaporation, alkoxide decomposition, co-precipitation, hydrothermal method. The surfaces of the conductive inorganic particles may be treated with, for example, a nonionic surfactant, cationic surfactant, anionic surfactant, silicone coupling agent, aluminum coupling agent and the like.

It is preferable that the solvent for adjusting the viscosity of the coating composition can dissolve the curable compound and volatilizes after application of the coating composition. Non-limiting examples of the solvent may include alcohols such as diacetone alcohol, methanol, ethanol, isopropyl alcohol or 1-methoxy-2-propanol; ketones such as acetone, methyl ethyl ketone or methyl isobutyl ketone; aromatic hydrocarbons such as toluene or xylene; esters such as ethyl acetate; Cellosolves such as 2-ethoxyethanol or 2-buthoxy ethanol; and water. The amount of the solvent used in the coating composition is determined depending upon the property of the curable compound.

Mixing the solvent to the coating composition can promote the dispersion of the conductive inorganic particles in the coating composition. In the mixing of the conductive inorganic particles, the conductive inorganic particles may be mixed with the curable compound after the conductive inorganic particles are mixed with a solvent, or the conductive inorganic particles may be added to a mixture of the curable compound and the solvent.

When the coating composition is solidified and hardened by irradiation of ultraviolet rays, it is preferable to add a photopolymerization initiator to the coating composition prior to the UV irradiation. Non-limiting examples of the photopolymerization initiator may include benzyl, benzophenone or its derivatives, thioxanthones, benzyl dimethyl ketals, α-hydroxyalkylphenones, hydroxyketones, aminoalkylphenones and acylphosphine oxides. The photopolymerization initiator is generally added in an amount of 0.1 to 5 parts by weight per 100 parts by weight of the curable compound. In the case where the curable coating composition contains the solvent, the coating composition is applied and the solvent is allowed to be vaporized, and thereafter, the curable film of the coating composition may be hardened. Vaporization of the solvent and hardening of the curable film may be carried out simultaneously.

The second flat plate 22 which partitions the cavity 26 in cooperation with the first flat plate 20 will be described below in detail.

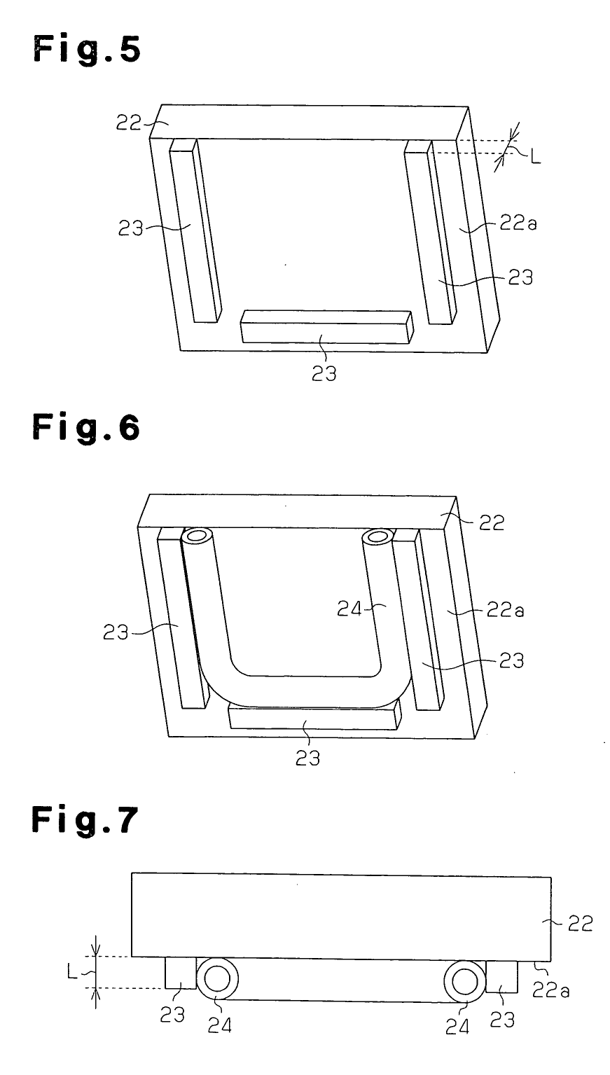

As shown in FIG. 5, on the surface 22a of the second flat plate 22, three rectangular bars 23 for defining the plate thickness are fixed along the outer edge of the surface by a fixing member such as an adhesive or the like. The thickness L of each rectangular bar 23 is determined according to the thickness of the methacrylic resin molded article 30 to be produced. In the first embodiment, the thickness of the methacrylic resin molded article 30 is in the range of about 0.2 to 10 mm.

As shown in FIG. 6, inside the three rectangular bars 23, a tube 24 made of an elastic material such as silicone resin and the like is arranged along the rectangular bars 23. As shown in FIG. 7, the tube 24 has an outer diameter slightly larger than the thickness L of the rectangular bar 23, namely the thickness of the molded article 30.

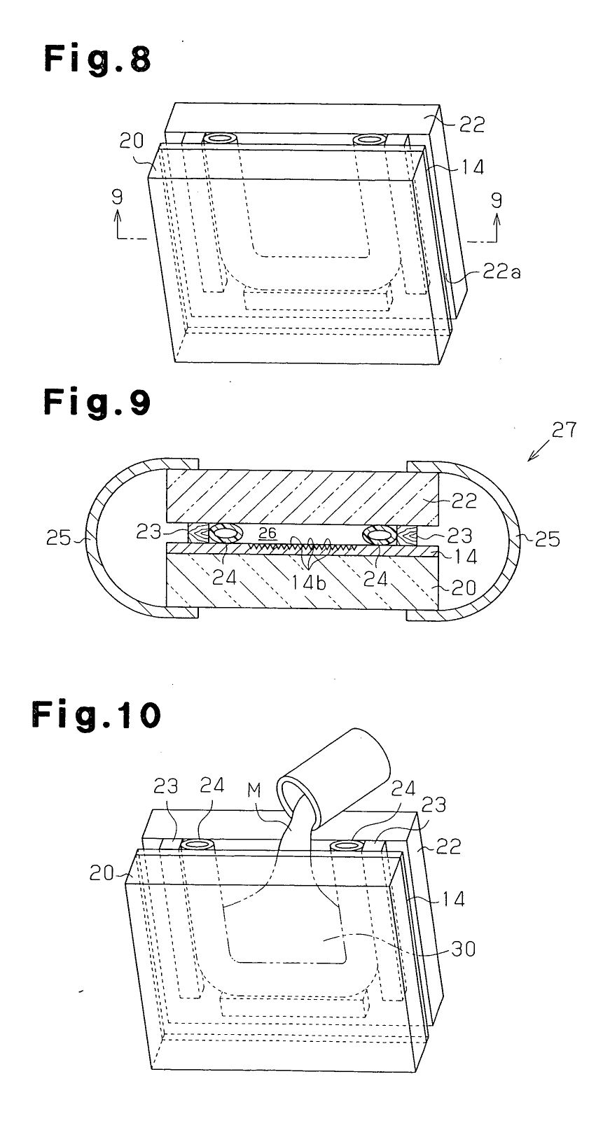

As shown in FIG. 8, the flat plate 20 and the second flat plate 22 are arranged to be faced each other so that the rectangular bars 23 and the tube 24 surround a negative pattern of the first flat plate 20.

As shown in FIG. 9, the first plate 20 and the second flat plate 22 are jointed and fastened with fasteners 25. By this fastening, the tube 24 is elastically deformed, the flat plates 20 and 22 are separated with a distance of the thickness L of the rectangular bar 23 while they are faced each other and the cavity 26 sealed by the tube 24 is partitioned. In the above manner, the cell 27 is completed. FIG. 9 is a cross-sectional view taken along the line 9-9 of FIG. 8 in such a condition that the cell 27 has been accomplished.

Next, in the step 2, the resin composition M is injected into the cavity 26 of the accomplished cell 27, as shown in FIG. 10. In FIG. 10, the fasteners 25 are not shown.

In the component A of the resin composition M, the unsaturated monomer A1 is a mixture containing not less than 50% by weight of methylmethacrylate and other monofunctional unsaturated monomer capable of polymerizing with the methylmethacrylate.

Non-limiting examples of the other monofunctional unsaturated monomer may include esters of methacrylic acid or acrylic acid and aliphatic, aromatic or alicyclic alcohol such as methylmethacrylate, ethyl methacrylate, propyl methacrylate, butyl methacrylate, 2-ethylhexyl methacrylate, lauryl methacrylate, tetrahydrofurfuryl methacrylate, isobornyl methacrylate, benzyl methacrylate or cyclohexyl methacrylate; (meth)acryl monomers of hydroxyalkyl esters such as hydroxyethyl methacrylate, hydroxypropyl methacrylate or hydroxybutyl methacrylate; unsaturated acids such as acrylic acid or methacrylic acid; styrene monomers such as styrene or α-methylstyrene; and monofunctional unsaturated monomers such as acrylonitrile, methacrylonitrile, maleic anhydride, phenyl maleimide, cyclohexylmaleimide or vinyl acetate.

These other monofunctional unsaturated monomers may be used singly or in combination with two or more. The molecule of the other monofunctional unsaturated monomer has one radically polymerizable double bond.

The unsaturated monomer A1 has a methyl methacrylate content of not less than 50% by weight, preferably not less than 70% by weight, more preferably not less than 90% by weight. The transparency of the finally obtained methacrylic resin is improved as the content of methyl methacrylate is higher.

In the component A of the resin composition M, non-limiting examples of the unsaturated monomer A2 may include allyl methacrylate, ethyleneglycol dimethacrylate, diethylene glycol dimethacrylate, triethyleneglycol dimethacrylate, polyethyleneglycol dimethacrylate, polypropyleneglycol dimethacrylate, 1,3-butyleneglycol dimethacrylate, 1,6-hexanediol dimethacrylate, neopentylgycol dimethacrylate, divinylbenzene, diallylphthalate, trimethylolpropane trimethacrylate, tetramethylolmethane trimethacrylate or tetramethylolmethane tetramethacrylate.

These polyfunctional unsaturated monomers may be used singly or in combination with two or more.

In the case of producing molded articles having excellent heat resistance, impact strength and mechanical strength, the component A preferably has a content of the unsaturated monomer A1 of from 20 to 90% by weight and a content of the unsaturated monomer A2 of from 10 to 80% by weight. When the content of the unsaturated monomer A2 is less than 10% by weight, molded articles having relatively low heat resistance are produced. When the unsaturated monomer A2 is more than 80% by weight, molded articles having relatively low impact strength and mechanical strength are produced.

In these unsaturated monomer mixtures, a homopolymer of the polyfunctional unsaturated monomers, a homopolymer of the monofunctional unsaturated monomers or a copolymer of the polyfunctional unsaturated monomers and the monofunctional unsaturated monomers may be dissolved and contained.

The amount of the component A is ranged about 30 to 60 parts by weight per 100 parts by weight of the total of the components A and B. When the amount of the component A is less than 30 parts by weight, the resin composition M has low fluidity and is difficult to be cast. When the amount of the component A is more than 60 parts by weight, a soft casting material prepared by mixing and kneading the resin composition M has a sticky surface, no good handling properties and difficulty in shape maintaining. Further, because it is shrunk largely during polymerization, it is difficult to prepare molded articles having a smooth surface.

The component B is polymer particles of an unsaturated monomer comprised of methyl methacrylate as a major component. The particles are comprised of partially crosslinked polymer particles and non-crosslinked polymer particles. The polymer particles are resin particles of a copolymer of methyl methacrylate with other unsaturated monomer capable of copolymerizing with methyl methacrylate. The proportion of methyl methacrylate is not less than 50% by weight in the constitution components of the polymer particles.

Non-limiting examples of the other unsaturated monomer capable of copolymerizing with methyl methacrylate may include the above described polyfunctional unsaturated monomers (A2) and the above described other monofunctional unsaturated monomers. Non-limiting examples of the other monofunctional unsaturated monomer may include esters of methacrylic acid or acrylic acid and aliphatic, aromatic or alicyclic alcohol such as methylmethacrylate, ethyl methacrylate, propyl methacrylate, butyl methacrylate, 2-ethylhexyl methacrylate, lauryl methacrylate, tetrahydrofurfuryl methacrylate, isobornyl methacrylate, benzyl methacrylate or cyclohexyl methacrylate; (meth)acryl monomers of hydroxyalkyl esters such as hydroxyethyl methacrylate, hydroxypropyl methacrylate or hydroxybutyl methacrylate; unsaturated acids such as acrylic acid or methacrylic acid; styrene monomers such as styrene or α-methylstyrene; and monofunctional unsaturated monomers such as acrylonitrile, methacrylonitrile, maleic anhydride, phenyl maleimide, cyclohexylmaleimide or vinyl acetate. Non-limiting examples of the unsaturated monomer may include allyl methacrylate, ethyleneglycol dimethacrylate, diethylene glycol dimethacrylate, triethyleneglycol dimethacrylate, polyethyleneglycol dimethacrylate, polypropyleneglycol dimethacrylate, 1,3-butyleneglycol dimethacrylate, 1,6-hexanediol dimethacrylate, neopentylgycol dimethacrylate, divinylbenzene, diallylphthalate, trimethylolpropane trimethacrylate, tetramethylolmethane trimethacrylate or tetramethylolmethane tetramethacrylate.

Non-limiting examples of the polymer particles of the component B used herein may include polymer particles obtainable by, for example, emulsion polymerization, suspension polymerization or dispersion polymerization, and further may include polymer particles obtainable by grinding a polymer prepared by other polymerization method. The diameter of the polymer particles used herein is generally ranged about 1 to 100 μm. In the case of using polymer particles having a diameter of less than 1 μm, it is likely difficult to mix and knead the polymer particles with the unsaturated monomer mixture (component A). It is not preferred to use polymer particles having a diameter of over 100 μm because molded articles having a prominent particle shape are produced. In the polymer particles of the component B, about 20 to 100% by weight of the polymer particles are partially crosslinked ones and about 0 to 80% by weight of the polymer particles are non-crosslinked ones. It is not preferred that the proportion of the partially crosslinked polymer particles in the polymer particles be less than 20% by weight, because the soft casting material obtained after mixing and kneading the resin composition M has not good handling properties.

The partially crosslinked polymer particles are swellen by contacting with a solvent (acetone or the like) capable of dissolving methyl methacrylate, but is not dissolved completely. Such polymer particles are prepared in the following manner. First, the mixture of methyl methacrylate and the unsaturated monomer capable of copolymerizing with methyl methacrylate is prepared. The amount of methyl methacrylate in the mixture is not less than 50% by weight. To the mixture, the polyfunctional unsaturated monomer is added. The polyfunctional unsaturated monomer-added mixture is polymerized to prepare polymer particles or a polymer.

The amount of the component B is ranged about 40 to 70 parts by weight per 100 parts by weight of the total of the components A and B. When the amount of the component B is less than 40 parts by weight, the soft casting material prepared by mixing and kneading the resin composition M has a sticky surface and thereby the handling properties thereof become inferior. When the amount of the component B is more than 70% by weight, it is difficult to conduct uniform mixing and kneading thereof.

To the polymer particles, it is possible to add known additives, for example, an antioxidant, an ultraviolet absorber, a chain transfer agent, a mold release agent, a dye, a pigment and inorganic fillers as necessary.

The component C is a radical initiator used for hardening the unsaturated monomer mixture (component A) with polymerization. Non-limiting examples of the radical initiator may include azo compounds such as 1,1′-azobis(cyclohexane-1-carbonitrile), 2,2′-azobis(2,4,4-trimethylpentene), 2,2′-azobis(2-methylpropane), 2-cyano-2-propyrazoformamide, 2,2′-azobis(2-hydroxy-methylpropionate), 2,2′-azobis(2-methyl-butyronitrile), 2,2′-azobisisobutyronitrile, 2,2′-azobis[2-(2-imidazolin-2-yl)propane] or dimethyl 2,2′-azobis(2-methylpropionate); diacyl or dialkyl peroxide initiators such as dicumyl peroxide, t-butylcumyl peroxide, di-t-butyl peroxide, benzoyl peroxide or lauroyl peroxide; peroxy ester initiators such as t-butylperoxy-3,3,5-trimethyl hexanoate, t-butylperoxy laurate, t-butylperoxy isobutyrate, t-butylperoxy acetate, di-t-butylperoxy hexahydroterephthalate, di-t-butylperoxyazerate, t-butylperoxy-2-ethyl hexanoate, 1,1,3,3-tetramethylbutylperoxy-2-ethyl hexanoate or t-amylperoxy-2-ethyl hexanoate; percarbonate initiators such as t-butylperoxyallyl carbonate or t-butylperoxyisopropyl carbonate; and peroxyketal initiators such as 1,1-di-t-butylperoxycyclohexane, 1,1-di-t-butylperoxy-3,3,5-trimethylcyclohexane or 1,1-di-t-hexylperoxy-3,3,5-trimethylcyclohexane.

The above radical polymerization initiators may be used singly or in a mixed state with two or more kinds thereof. The amount of the radical polymerization initiator is from 0.1 to 5 parts by weight per 100 parts by weight of the total of the components A and B. When the amount of the radical polymerization initiator is less than 0.1 parts by weight, the performing of radical polymerization requires a long period of time. When the amount of the radical polymerization initiator exceeds 5 parts by weight, the unsaturated monomer mixture (component A) cannot be polymerized stably and thereby it is difficult to control the polymerization reaction.

To the resin composition M, it is possible to add a mold release agent, ultraviolet absorber, dye, pigment, modifier (polymerization controlling agent), chain transfer agent, antioxidant, flame retardant and reinforcer.

Before injecting the resin composition M, the mold release agent may be applied to the inner surface (cavity surface) of the cell 27. The mold release agent enables a molded article to be easily taken out from the cell 27. As the mold release agent, it is possible to employ known mold release agents capable of being added to methacrylic resins such as polymethyl methacrylate, etc. Non-limiting examples of the mold release agent may include stearic acid, stearyl alcohol, stearyl amide, silicone mold release agent and fluorine mold release agent.

Next, in the step 3, the resin composition M injected into the cavity 26 is stored for a while (matured). Specifically, the resin composition M is heated to a temperature of lower than 80° C., for example, 20 to 80° C., by maintaining the temperature of the cell 27 at said temperature. This maturing promotes mixing of the components constituting the resin composition M. For example, the unsaturated monomer mixture in the component A is dissolved in the component B. In a case where the polymer particles of the component B include non-crosslinked particles, the non-crosslinked particles are dissolved by the component A. In this manner, these components are uniformly mixed.

In maturing step, it is not preferred to carry out the maturing at a temperature of over 80° C. because it has a possibility of starting polymerization and curing reaction by the added radical polymerization initiator. When the maturing is carried out at a temperature lower than 20° C., the maturing takes a long period of time. The maturing conditions can be appropriately altered according to the used polymer particles, the composition of the unsaturated monomer mixture, and the kind and the amount of the used initiator.

In the step 4, the resin composition M is polymerization reaction in the cell 27. In the first embodiment, heat treatment is carried out for accelerating polymerization reaction of the resin composition M.

FIG. 11 shows a cell 27 storing the injected resin composition M. One or a plurality of the cells 27 can be placed in a polymerization chamber not shown. The cell 27 is heated with a heating source not shown, such as warm air, warm water or infrared heater in the polymerization chamber and also pressurized. In general, the heating temperature is from 50 to 130° C. and the heating time is from several ten minutes to several ten hours. The conditions of the heat treatment can be changed depending upon the kind or the added amount of the radical polymerization initiator. Through the heat treatment, the polymerization reaction of the resin composition M is accelerated and finally, the resin composition M is solidified to obtain a molded article (cast plate) 30 having a uniform composition.

The film having anti-scratching properties adhered on the surface (negative pattern surface of the mold plate 14) of the first flat plate 20 is adsorbed on the molded article in this polymerization (cast polymerization) step to form the surface layer of the molded article.

In the step 5, as shown in FIG. 12, the fixing of the first and second flat plates 20, 22 is released to take the cell 27 apart and then the methacrylic resin molded article 30 produced by solidifying the resin composition M is taken out from the cell 27.

The region Z of the methacrylic resin molded article 30 is the surface corresponding to the negative pattern in the mold plate 14 and has projections 30a formed by transferring of the negative pattern of the mold plate 14.

The methacrylic resin molded article 30 is trimmed into a desired size as shown in FIG. 13 or cut into pieces each having a desired size. In this way, the methacrylic resin molded article 30, which has the surface fine structure including the projections 30a formed on an entire surface, is produced.

The structure of the methacrylic resin molded article 30 will be described.

As shown in FIG. 14, on the surface of the methacrylic resin molded article 30, the projections 30a on which the negative pattern is transferred are formed. When the pitch P1 and the height T1 of the projection 10b of the master as shown in FIG. 2C are 265 nm and 318 nm respectively, the pitch P2 and the height T2 of the projection 30a of the resin molded article 30 are 265 nm and 315 nm respectively. The present inventors confirmed that when the mold plate 14 as shown in FIG. 3 is formed from the master 13 as shown in FIG. 2C, the pattern transfer fidelity of the methacrylic resin molded article 30 with respect to the mold plate 14 is about 99% or more although somewhat precision deterioration is accompanied. The pitch P2 and the height T2 support the high pattern transfer fidelity.

As shown in FIG. 14, the methacrylic resin molded article 30 has the surface layer composed of the film 30b having anti-scratching properties transferred from the surface of the mold plate 14 in one integral body.

FIG. 15 shows a graph showing correlation between the reflectance and the wavelength of incident light with respect to the methacrylic resin molded article 30 of the first embodiment and a conventional AR optical element with a multi-layer film.

In FIG. 15, the curved line TM shows the properties of the AR optical element with a multi-layer film formed using a deposition method (conventional technique). The curved line MC shows the properties of the molded article having a fine structure wherein the pitch of the projections 30a and the aspect ratio are 300 nm and 1 respectively (present invention). In FIG. 15, the properties measured of a molded article in which the film having anti-scratching properties 30b is not formed are shown in order to study the relation between the reflectance and the wavelength of the fine structure pattern more precisely.

As is clear from FIG. 15, the AR optical element with the conventional multi-layer film has a reflectance of not more than 1% in the wavelength region of from 400 nm to 580 nm, but the reflectance thereof cannot be suppressed to be lower in regions other than the above region. On the contrary, the methacrylic resin molded article 30 (MC) has a low reflectance in substantially all of the wavelength region of visible light and therefore it is found that the methacrylic resin molded article 30 of the present invention has high antireflection function. That is, it is found that the methacrylic resin molded article 30 having the above described fine structure pattern can realize suitable non-reflection function in wider wavelength regions.

The first embodiment has the advantages described below.

(1) The resin composition M is injected into the cell 27 provided with a negative pattern having a surface fine structure for realizing the AR function and is subjected to polymerization reaction in the cell 27, namely cast polymerization to prepare the methacrylic resin molded article 30 having a surface fine structure. When the resin composition M is spread into the fine negative pattern and solidified through polymerization reaction, the pattern having a surface fine structure and capable of realizing the AR function is transferred on the methacrylic resin molded article 30 with very high pattern transfer fidelity. Employment of cast polymerization improves the productivity of the methacrylic resin molded article 30. Accordingly, the methacrylic resin molded article 30 having very high precise surface fine structure can be produced with mass production inexpensively.

In the case of forming the methacrylic resin molded articles having a surface fine structure, it is important to spread the casting material into the fine pattern of the cell 27. Taking account of this point, it would be preferred to inject a monomer such as methyl methacrylate into the cell 27. However, methyl methacrylate is shrunk when it is polymerized and hardened. The shrinkage of methyl methacrylate is a considerably high degree and it can not be ignored. Therefore, the reversal fine pattern of the cell 27 cannot be transferred on the molded article with high pattern transfer fidelity. On the contrary, when the casting material is a methyl methacrylate polymer, the shrinkage problem is suppressed. However, the methyl methacrylate polymer does not spread into the fine pattern of the cell 27 in a satisfactory manner. Therefore, it is impossible to transfer the fine pattern of the cell 27 onto the molded article with high pattern transfer fidelity.

In the present invention, the resin composition M, which has an intermediate property of a monomer and a polymer, is used. The use of the resin composition M, both of merits of the monomer and merits of the polymer are obtained and the fine pattern of the cell 27 can be transferred on the molded article with very high pattern transfer fidelity. Accordingly, the methacrylic resin molded article 30 according to the first embodiment is preferable as an optical element having high optical properties.

(2) The resin composition M used in the invention includes not less than 50% by weight of methyl methacrylate and the other monomer capable of copolymerizing with the methyl methacrylate. Making use of the resin composition, the obtained methacrylic resin molded article 30 has high transparency, weathering resistance and hardness.

(3) The resin composition M to which the radical polymerization initiator has been added is heated in the cell 27. Making use of the radical polymerization initiator favorably accelerates the polymerization reaction of the resin composition.

(4) Prior to injection of the resin composition M to the cell 27, the coating composition containing the curable compound and conductive fine particles is applied on the negative pattern surface of the mold plate 14. Accompanying with cast polymerization, the applied coating composition is adsorbed on the surface layer of the methacrylic resin molded article having a surface fine structure and thereby the film having anti-scratching properties 30b is imparted to the molded article. The film having anti-scratching properties 30b improves the function of protecting the surface fine structure (hard coat) or the reliability and practicability of the methacrylic resin molded article having the antistatic function and the surface fine structure. Essentially, the methacrylic resin molded article is difficult to be surface-treated, but the surface layer of the methacrylic resin can be accurately surface-treated with the coating composition by carrying out adhesion of the coating composition together with the polymerization reaction of the resin composition M. In the first embodiment, when taking out from the cell 27, the film having anti-scratching properties 30b has been already formed on the surface of the methacrylic resin molded article 30. Therefore, even if methyl methacrylate is used as a major component, no good conditions such as incorporation of foreign matters between the methacrylic resin molded article 30 and the film having anti-scratching properties 30b or the like can be controlled.

(5) As described above, since the very high pattern transfer fidelity of the surface fine structure, specifically the pattern transfer fidelity of not less than 99% is attained, the methacrylic resin molded article having a surface fine structure (antireflection structure) that the aspect ratio is 1 or more and the pitch is ranged about 250 to 300 nm can be realized with relatively ease although it depends the production precision of the mold plate 14. Because the pitch of from 250 to 300 nm is less than the wavelength of visible light, the methacrylic resin molded article having a surface fine structure is used to a display of various electronic devices so that the reflection of the display can be suppressed and the visibility can be enhanced.

(6) By the process for producing the methacrylic resin molded article 30 with the steps 1 to 5, the methacrylic resin molded article to which the pattern having a surface fine structure has been transferred with very high pattern transfer fidelity can be easily produced with high efficiency.

(7) Prior to the step 1, the mold plate 14 which is to be a stamper mold is produced by electrocasting based on the master 13 having a precisely fine structure and thereby the negative pattern itself can be produced with high precision. Therefore, the resin plate having the desired optical properties can be obtained surely.

(8) Since the polymerization reaction is carried out in the cell 27, the resin composition M is solidified and hardened without changing the orientation of the resin composition M. Due to this hardening, the molded articles having lowered strain and optically excellent properties can be produced as compared with those produced by compression molding or injection molding. Polymerization of the resin composition M prepares the molded articles having high thermal, chemical and mechanical properties such as surface hardness, rigidity, heat resistance, strength, solvent resistance and the like.

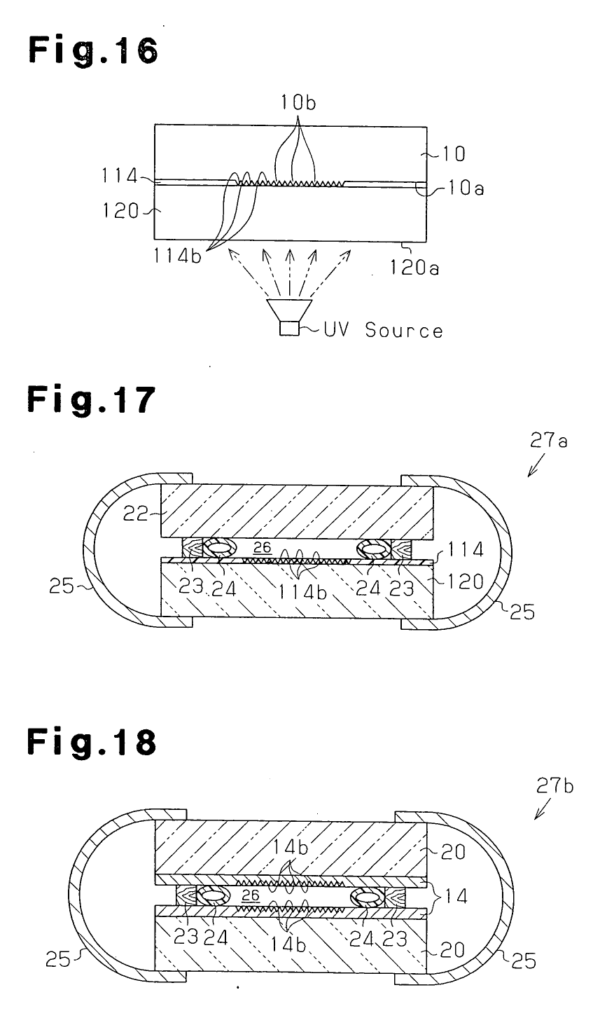

The methacrylic resin molded article having a surface fine structure according to the second embodiment of the present invention and the production process thereof are described in detail mainly on the points different from the first embodiment with reference to FIGS. 16 and 17. In FIGS. 16 and 17, with regard to the elements same as or corresponding to the elements of the first embodiment as shown in FIGS. 1 to 15, the same or corresponding signs are appended and the descriptions thereof are omitted.

The methacrylic resin molded article having a surface fine structure according to the second embodiment can have AR (antireflection or non-reflection) function with optically high accuracy by the fine structure pattern having very high accuracy transferred on the surface of the methacrylic resin molded article. The production process thereof is described below.

In the second embodiment, a batch casting method is employed in which at least one cell 27a having a cavity 26 defined between two flat plates is repeatedly used. A methacrylic resin molded article having a surface fine structure is produced through steps 1 to 5 similar to those of the first embodiment.

Be noted that in the second embodiment, a mask pattern is used in place of the mold. Thus, in the preliminary steps for producing the negative pattern corresponding to the desired fine structure, the step b2 for forming the mask pattern having transmitting properties is carried out after the step a1 for producing the master.

The step b2 for forming the mask pattern is described. As shown in FIG. 16, the substrate 10 having the surface (fine structure surface) 10a with a fine structure formed from the conical projections 10b is used as a master. Between the surface 10a of the substrate 10 and a flat plate 120 made of a transparent material such as glass or quartz, an ultraviolet ray curable resin is injected. The surface 10a of the substrate 10 is abutted with the flat plate 120. The ultraviolet curable resin on the flat plate 120 is solidified and hardened by irradiating ultraviolet rays from an UV light source located at the side of the back surface 120a of the flat plate 120, to form a resin layer 114.

In this manner, to the resin layer 114 provided with the flat plate 120 in one united body, the fin structure pattern of the substrate 10 is exactly transferred in a reverse manner by irradiating with ultraviolet rays on the flat plate 120. That is, the negative pattern including the recess 114b corresponding to the projections 10b of the substrate 10 is formed on the resin layer 114.

Thereafter, similar to the first embodiment, the coating composition is applied on the surface of the flat plate 120 and is solidified and hardened accurately on the upper surface of the resin layer 114 formed with the negative pattern to form a film having anti-scratching properties (not shown). In the subsequent step, the film having anti-scratching properties is transferred on the surface of the methacrylic resin molded article 30. The coating composition which is the same as in the first embodiment can be used as the coating composition.

Next, the cell 27a is formed in the same manner as in the step 1 of the first embodiment. That is, the flat plate 120 is used in place of the flat plate 12, the second flat plate 22, the rectangular bars 23 and the tube 24 composed of an elastic material such as silicone resin or the like are assembled and the two flat plates 120, 22 are fastened by the fasteners 25. According to this fastening, the cavity 26 partitioned between the two flat plates 120, 22 is sealed by the tube 24, to finish the cell 27a.

As shown in FIG. 17, the cell 27a is basically the same as the cell 27 in the first embodiment and the flat plates 120, 20 are separated in opposition to each other with a distance corresponding to the thickness of the rectangular bar 23. On one inner surface, which partitions the cavity 26, of the cell 27a, the resin layer 114 having the negative pattern (recess 114b) is provided as described above.

Next, in the step 2, the resin composition M containing methyl methacrylate as a major component is injected into the cell 27a (cavity 26). The component C of the resin composition M of the second embodiment is a photopolymerization initiator not a radical polymerization initiator.

Non-limiting examples of the photopolymerization initiator may include benzyl, benzophenone or its derivatives, thioxanthones, benzyl dimethyl ketals, α-hydroxyalkylphenones, hydroxyketones, aminoalkylphenones and acylphosphine oxides.

The resin composition M containing the components A, B and C is subjected to the maturing treatment (step 3) in the cell 27a similar to the first embodiment.

Thereafter, in the step 4, the resin composition M is polymerized. It is subjected to irradiation treatment with ultraviolet rays in order to accelerate the polymerization reaction. One or a plurality of the cells 27a are accommodated in a polymerization chamber not shown and then ultraviolet ray irradiation is carried out. Through the ultraviolet ray irradiation treatment, the polymerization reaction of the resin composition M filled in the cell 27a is accelerated and the resin composition M is solidified finally.

In this photopolymerization step, the film (resin layer 114) having anti-scratching properties formed on the surface of the flat plate 120 is adsorbed on the surface layer of the methacrylic resin molded article 30 produced by solidifying the resin composition M.

In the step 5 similar to the first embodiment, the methacrylic resin molded article 30 having a surface fine structure same as one shown in FIG. 14 is accomplished.

According to the second embodiment, the effects similar to the effects (1) to (8) in the first embodiment can be attained. Further, in the second embodiment, the resin layer 114 which functions as a negative pattern can be directly formed on the flat plate 120 so that the step of separately providing the negative pattern can be omitted and thereby the working efficiency is further improved.

It should be apparent to those skilled in the art that the present invention may be embodied in many other specific forms without departing from the spirit or scope of the invention. Particularly, it should be understood that the present invention may be embodied in the following forms.

In the first embodiment, the mold plate 14 is fixed on the flat plate 20 by the screw 21 and the fixing condition of the mold plate 14 can be appropriately altered. For example, an outer frame fitting with the outer shape of the mold plate 14 is previously formed and then the mold is mounted on this outer frame. Furthermore, the mold plate 14 and the flat plate 20 may be directly fixed using an appropriate adhesive or the like. As optical elements realizing desired optical properties by changing the effective refractive index with the surface fine structure, there are many optical elements such as optical elements having antireflection function, optical elements having polarization split function and the like. Accordingly, plural kinds of negative patterns corresponding to the surface fine structure of various kinds of optical elements can be produced. Therefore, it is preferred to employ the mechanism capable of mounting or demounting the mold plate 14 (negative pattern) to the flat plate 20, namely capable of exchanging. In this case, the negative pattern is easily changed so that the mechanism can easily meet the production of plural kinds of methacrylic resin molded articles having a surface fine structure with various different optical properties.

In each embodiment, the negative pattern having a surface fine structure is provided on one of the flat plates partitioning the cavity 26, and further, the embodiment of the negative pattern arrangement can be appropriately altered depending upon the desired optical properties. For example, as shown in FIG. 18, a molded article may be produced using the cell 27b mounted with the mold plate 14 such that the two flat plates 20 in opposition to each other have a negative pattern respectively. In this case, the methacrylic resin molded article having a surface fine structure on both surfaces is produced. This case likewise applies to the second embodiment using the negative pattern composed of the ultraviolet ray curable resin layer 114 as shown in FIG. 16 and FIG. 17.

In each embodiment, the master 13 has the projections 10b arranged two-dimensionally (FIG. 2C). The arrangement of the projections 10b are optional, for example, the row of the projections 10b may be arranged diagonally as hexagonal closest packing array. By this arrangement, the exposed area of the surface 10a of the substrate 10 is further decreased so that it is expected that the methacrylic resin molded articles having more excellent antireflection effect can be produced.

The surface fine structure of each embodiment has conical projections 30a having a pitch of from 250 nm to 300 nm and a height (depth) of from 300 nm to 500 nm. In the case that the light wavelength (□) is from 400 nm to 800 nm and the refraction index (n) is 1.5, the pitch required for the AR function is about 266 nm. That is, the pitch is a value determined by dividing the shortest wavelength 400 nm in the above wavelength ranges by the refraction index of 1.5. Basically, a pitch of about 250 nm may be secured in order to obtain the AR function of visible light. If the further improvement of processing accuracy is expectable, the pitch can be from 150 nm to 300 nm. In the case that the pitch is less than 150 nm, not only the change of the effective refraction index to visible light is not sufficiently utilized but also casting processing becomes difficult. In the case that the pitch is longer than 300 nm, phenomena such as reflection, interference or the like are likely to be induced in addition to the phenomenon that the aimed effective refraction index to visible light is changed, and further properties other than imparting of the AR function and polarized light separating properties are likely to be induced. Therefore, the pitch of longer than 300 nm is unfavorable.

The aspect ratio of the projections 10b is preferably 1 or more. The aspect ratio is a ratio of the height of the projection 10b (distance of from the apex of the projection 10 b to the surface of the substrate 10) to the distance of the apexes between the adjacent projections 10b (period of projections 10b). The larger the aspect ratio is, the sharply higher the projection 10b is. In the case that the aspect ratio is 1 or more, the desired optical properties such as AR function, polarization split function or other functions are effectively attained.

In each embodiment, prior to the injection of the resin composition M to the cavity 26, the coating composition capable of realizing anti-scratching properties or antistatic properties is previously applied on the negative pattern surface of the cavity 26. However, the material and the adding amount of the coating composition can be appropriately changed in accordance with the desired properties. For example, in the case of using a material having a refraction index higher than that of the methacrylic resin, the aspect ratio of the surface fine structure of the methacrylic resin molded article 30 is quasi-enhanced by the difference of the refraction index.

In the case where the methacrylic resin molded article 30 itself can secure anti-scratching properties, antistatic properties or the like, the surface treatment can be omitted.

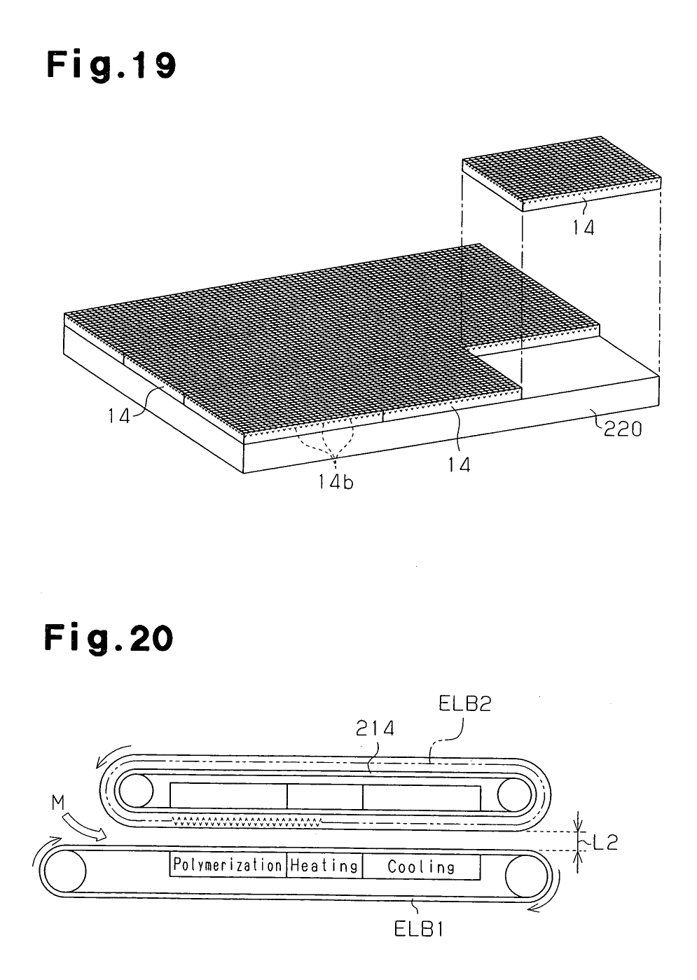

As the negative pattern, a pattern having an area corresponding to the plural substrates 10 to be a master may be used. That is, productivity of the master is generally low. The material of the substrate 10, such as silicon, quartz or the like, is normally difficult to be processed. Therefore, it is difficult to prepare a large-sized substrate 10. Accordingly, it is possible to make the mold plate 14 having a large area by successively changing the position using at least one master. For example, as shown in FIG. 19, the plural the molds 14 produced based on one master are connected on the flat plate (glass plate) 220 and thereby the negative pattern having a large area can be also produced. Using the large-sized negative pattern, a methacrylic resin molded article having a surface find structure of a large area can be produced. This production is also attained in the second embodiment. The ultraviolet ray curable resin layer 14 is hardened by successively changing the position off the master on the flat plate 120, or the plural transparent plate members (flat plates) produced by hardening the ultraviolet ray curable resin layers 114 formed based on one master are connected so that the negative pattern having a large area can be produced.

In the second embodiment, on the upper surface of the flat plate 120, the ultraviolet ray curable resin layer 114 is directly formed as a negative pattern, and further, the ultraviolet ray curable resin layer 14 may be separately formed on other transparent plate member and this plate material may be attached to the flat plate 120. In this case, although the step of attaching the plate material to the flat plate 120 is added, plural kinds of negative patterns which can mutually realize different optical properties are mounted and demounted, and the mounting thereof is carried out through an exchangeable mechanism so that molded articles having plural kinds of surface fine structures corresponding to various optical properties can be produced.

In each embodiment, the negative pattern of the mold plate 14 is transferred to the ultraviolet curable resin layer 114 and forms the surface fine structure. The negative pattern may be directly formed on a surface of the flat plates 20 and 22 by semiconductor processing technique or electron beam processing technique. In this production, the mass productivity of the cell is inferior, but the production of the methacrylic resin molded article having a higher accuracy having surface fine structure can be attained together with very high pattern transfer fidelity for cast polymerization. In the present invention, the method of forming the negative pattern can be arbitrarily selected.

Within the range capable of attaining a sufficient pattern transfer fidelity, the component A of the resin composition M is not always limited to a complete monomer and may be a mixture pre-polymerized, that is, one having relatively high viscosity.

In the first embodiment, the heat treatment is carried out in order to accelerate the polymerization reaction of the resin composition M filled in the cell 27. When the flat plate 22 opposite to the mold plate 14 is composed of a material having transmitting properties such as glass, quartz or the like, ultraviolet ray irradiation treatment employed in the second embodiment can be carried out in place of the heat treatment.

In the second embodiment, the polymerization reaction of the resin composition M filled in the cell 27a is accelerated by carrying out the ultraviolet ray irradiation treatment. The heat treatment employed in the first embodiment may be also applied on the second embodiment although depending upon the conditions thereof.

In each embodiment, the heat treatment or the ultraviolet ray irradiation treatment is carried out in order to accelerate the polymerization reaction. The acceleration of the polymerization reaction (heating, ultraviolet ray irradiation, addition of polymerization initiator) can be changed or omitted.

In each embodiment, the cast polymerization with a batch casting method is employed. However, the present invention is not limited to the batch casting method, and can employ cast polymerization with a continuous cell cast method such that the resin composition M is subjected to polymerization reaction in a conveyer belt type continuous (endless) cavity to solidify it. The process for producing the methacrylic resin molded article using cast polymerization with the continuous cast method will be described. The cast polymerization with the continuous cast method includes the following steps:
step 1A: a conveyer belt type continuous cell provided with the negative pattern corresponding to the desired surface fine structure is formed on at least one surface of the two surfaces in opposition to each other;
step 2A: The resin composition M is injected into the cavity of the continuous cell;
step 3A: The resin composition M is subjected to polymerization reaction in the continuous cell (casting chamber); and
step 4A: The resin solidified by the polymerization reaction is cut out into the desired size.

FIG. 20 schematically shows one example of an apparatus used for the cast polymerization with the continuous cast method. The apparatus in FIG. 20 is provided with a pair of endless belts ELB1 and ELB2 which are continuously driven. The endless belts ELB1 and ELB2 are separated by a distance L2 so that a space is defined therebetween. The endless belts ELB1 and ELB2 are made of, for example, a stainless steel alloy. Between the endless belts ELB1 and ELB2, the resin composition M is continuously injected as shown by a white arrow in FIG. 20. With driving of the endless belts ELB1 and ELB2, the resin composition M is moved in this order of a polymerization zone, a heat treatment zone and a cooling zone. As shown in FIG. 20, a thin metal foil mold 214 having a negative pattern corresponding to the desired surface fine structure is continuously (in an endless manner) arranged on the allover of the endless belt ELB2. Basically, similar to the mold plate 14, a negative pattern including projections with a pitch of from 250 nm to 300 nm and each having a height of from 300 nm to 500 nm is formed on the mold 214. Further, both sides of the space between the endless belts ELB1 and ELB2 are sealed with partitions not shown to form a casting chamber. The steps 2A to 5A are the same as the steps 2 to 5 in the first embodiment. The cast polymerization with the continuous cell cast method does not have a step of separating the cells 27, 27a to take out the methacrylic resin molded article 30 of the methacrylic resin solidified by the polymerization reaction, so that the methacrylic resin molded article having a high accuracy having surface fine structure can be produced in large quantity inexpensively.

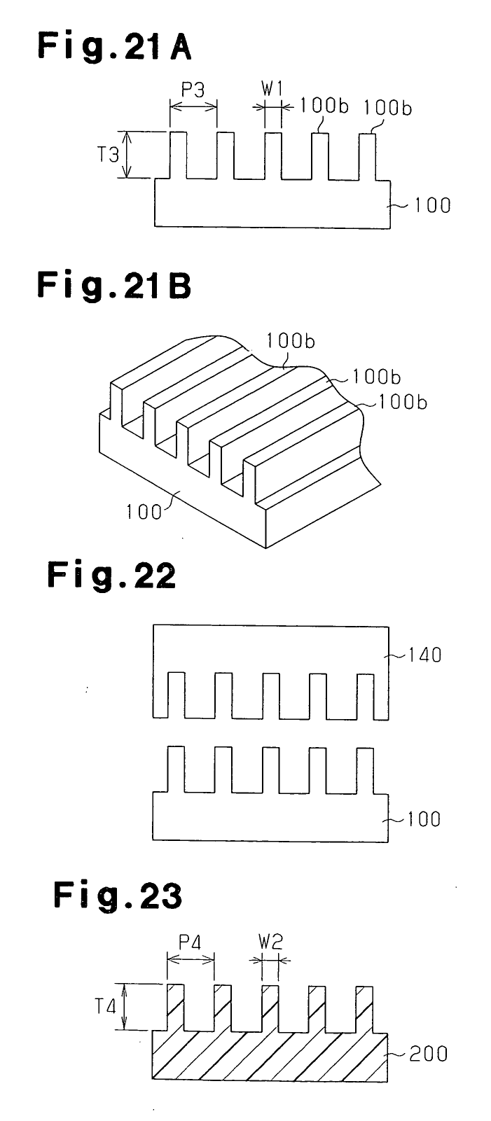

In each embodiment, the fine structure of the master (refer to FIG. 2C) includes conical projections 10b provided in a matrix form in order to realize the antireflection (AR) function. The master fine structure may comprise plural thin line-like projections having a rectangular cross-section arranged in parallel to each other. In this case, optical elements having polarization split function and polarized light converting function can be produced. The master for forming such optical elements is basically produced by the method similar to one as shown in FIGS. 1A to D. That is, on the surface of the substrate, a fine pattern having a submicron order of less than the wavelength of light is formed as a mask composed of a chromium film. As the fine pattern, lines having a pitch P3 (refer to FIG. 21A) are exemplified. Using the mask having a fine pattern, rectangular grooves are formed by anisotropic etching such as reactive ion etching or the like. Thereafter, the chromium film is removed and thereby a master 100 with rectangular elongated linear projections 100b each having a height T3 from about 200 to 1800 nm, a width W1 of from about 150 to 210 nm and arranged with a pitch P3 of from 350 to 450 nm is formed on the substrate as shown in FIGS. 21A and B. Similar to FIG. 3, a mold plate 140 using the master 100 is produced through, e.g. the electrocasting using nickel (Ni) as shown in FIG. 22. Using the mold plate 140, a methacrylic resin molded article can be formed in the procedure same as in each embodiment. As shown in FIG. 23, projections having polarization split function (polarized light separating structure) on which the above negative pattern has been transferred are formed on the surface of a molded article 200. The projections have a pitch P4 of about 450 nm, and each projection has a height T4 of 700 nm and a width W2 of about 150 nm and the pattern transfer fidelity is more than 99%. In this case, the aspect ratio is 4 or more. Because of this fine structure, favorable polarized light separating properties are expected. Furthermore, in the case of using a mold having the similar fine structure, a molded article having polarized light converting function (polarized light converting structure) on which projections having a pitch P4 of about 420 nm, a height T4 of about 1800 nm and a width W2 of about 210 nm have been transferred is produced. In this case, the aspect ratio is 8 or more and favorable polarized light converting properties are expected. The methacrylic resin molded article having such a surface fine structure can mainly be applied to phase difference plates or the like. As described above, the inventors confirmed that according to the present invention, the surface fine structure having a pitch P4 of from 350 to 450 nm and an aspect ratio of 2 or more is transferred with pattern transfer fidelity of not less than 99%. In the case that the further improvement of the processing accuracy is expectable, the pitch may be lowered until 300 nm. In this case, the pitch can be in the range of from 300 to 500 nm. The aspect ratio can be increased to 4 or more, however, in the case of using with thin film formation, the aspect ratio of the methacrylic resin molded article is at least 2 or more so that sufficient polarized light separating properties and polarized light converting properties can be attained.

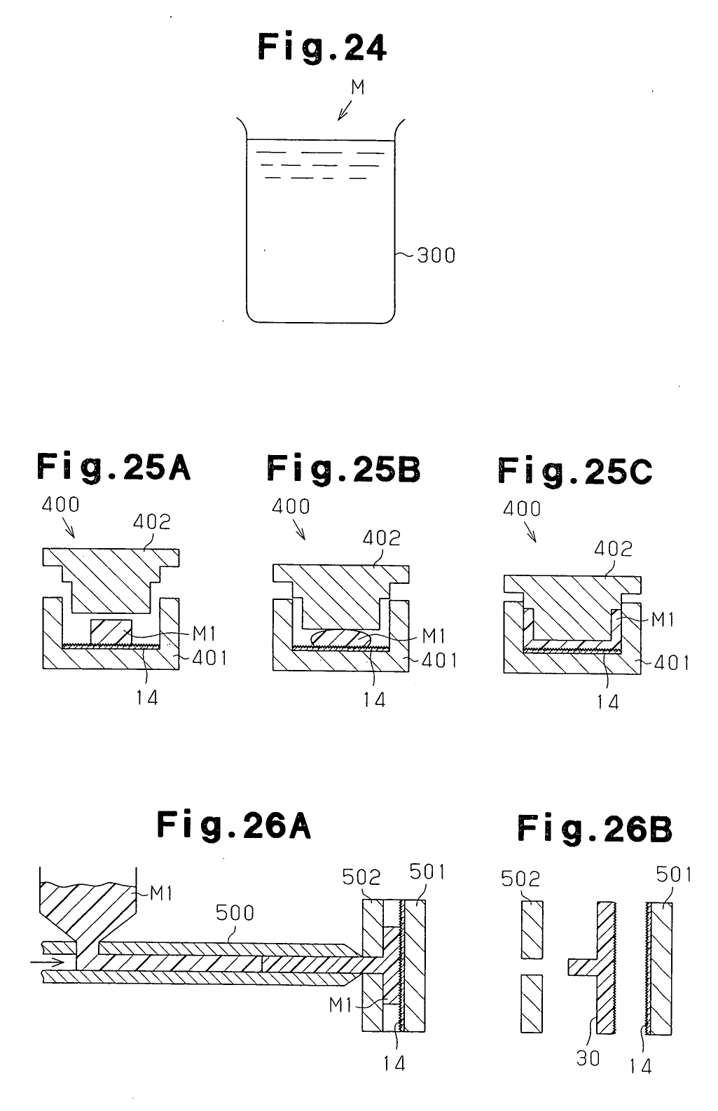

In each embodiment, the procedure of producing the methacrylic resin molded article having a surface fine structure by cast polymerization has been described. The casting using the resin composition M is not limited to the cast polymerization. For example, the resin composition M may be filled in the cavity between mold parts having a negative pattern with a surface fine structure capable of realizing the desired optical properties and then polymerized. Even in this case, a methacrylic resin molded article having a surface fine structure transferred with very high pattern transfer fidelity can be produced. An example thereof is shown in FIG. 24. In a container 300, the components A to C are mixed with stirring. In the container 300, the resin composition M is stored for a while (matured). The shape and the material of the container 300 are not limited. The mixing and the maturing of the resin composition M may be carried out with separate containers. By the maturing, a semisolid (rubbery, clay-like, powdery) casting material is prepared, which has a relatively high viscosity depending on kinds of the components of the resin composition M. The semisolid casting material is hardened with polymerization using a compression molding machine. As shown in FIG. 25A, a compression molding machine 400 includes two mold parts 401 and 402. A cavity is defined between the mold parts 401 and 402. A mold plate 14 is fixed on the bottom surface of one mold part (cylinder) 401. The semisolid casting material M1 is placed on the mold plate 14. As shown in FIG. 25B, the casting material M1 is compressed by the other mold part (piston) 402. The compression pressure is not less than 2 Kg/cm², preferably not less than 5 Kg/cm². As shown in FIG. 25C, the casting material M1 is filled in the cavity between the cylinder 401 and the piston 402. The casting material M1 is heated in this condition and thereby is polymerized. Thus, the cured molded article is produced for a short time. The pressurizing time and heating time are appropriately determined in accordance with the composition of the unsaturated monomer mixture in the casting material, the kind and the amount of the polymerization initiator, the thickness of the molded article and the temperature of the mold. Generally, the pressurizing time and the heating time are less than 10 min. Before placing the casting material M1, the cylinder 401 and the piston 402 may be heated to a prescribed temperature. On one or both of the cylinder 401 and the piston 402, a gas drawing vent or groove may be provided. In this case, the gas generated during the maturing or during the polymerization can be exhausted and thereby bubble remaining in the molded article is suppressed. The gas drawing vent or groove has a size such that the casting material M1 is not leaked out and the gas can be easily exhausted, and generally has a size of from about 0.01 to 0.5 mm. If the resin composition M is a composition having a high viscosity and low fluidity, the resin composition M is placed in the compression molding machine 400 before the maturing step, and the resin composition M may be stored for a while (matured) in the compression molding machine 400.

The semisolid casting material M1 may be hardened with polymerization using an injection molding machine 500. As shown in FIG. 26A, the cavity is partitioned between the mold part 501 and the mold part 502 on which the mold plate 14 is mounted. The semisolid casting material M1 introduced into the injection molding machine 500 is injected to the cavity with pressurizing and heating. The casting material M1 is hardened with polymerization in the cavity to prepare a methacrylic resin molded article 30. In this production process, even if the casting material M1 to be introduced into the injection molding machine 500 is in a slurry state or a semisolid state with low fluidity, the methacrylic resin molded article 30 can be produced in spite of its viscosity properties or fluidity.

In place of the mold plate 14 used in the production process as shown in FIGS. 25 and 26, the above various negative patterns can be used. In the case of using the ultraviolet ray curable resin 114 as exemplified in the second embodiment, the cylinder 401 (FIG. 25) or the mold part 501 (FIG. 26) may be made of transmittance materials. Further, in this case, the casting material M1 can be polymerized and hardened by photopolymerization. Even in this case, the pattern transfer fidelity of not less than 99% can be attained.

Prior to polymerizing the resin composition M, the resin composition is stored for a while (matured). If it is clear that a molded article having a uniform structure can be produced, the maturing of the resin composition M may be omitted. During heating in order to accelerate the polymerization reaction, the resin composition M is stored for a while (matured) to a great extent. Therefore, the promotion of mixing the components of the resin composition M may be carried out simultaneously with the heating for accelerating the polymerization reaction.

The present examples and embodiments are to be considered as illustrative and not restrictive, and the invention is not to be limited to the details given herein, but may be modified within the scope and equivalence of the appended claims.

1. A methacrylic resin molded article having a surface fine structure, the surface fine structure being formed by polymerizing a composition in a cell or cavity having an inner surface with a negative pattern corresponding to the surface fine structure subsequent to introducing the composition into the cell or cavity, the composition comprising:
(A) 30 to 60 parts by weight of an unsaturated monomer mixture, which mixture contains 20 to 90% by weight of an unsaturated monomer including methylmethacrylate as a major component, and 10 to 80% by weight of an unsaturated monomer having at least two polymerizable double bonds in one molecule;
(B) 40 to 70 parts by weight of particles made of a polymer of an unsaturated monomer including methylmethacrylate as a major component, which particles include 20 to 100% by weight of partially crosslinked polymer particles and 0 to 80% by weight of non-crosslinked polymer particles; and
(C) 0.1 to 5 parts by weight of a polymerization initiator per 100 parts by weight of the total of the above components A and B.

2. The methacrylic resin molded article according to claim 1, wherein the composition is a fluid resin composition including said components A, B, and C, and wherein the surface fine structure is formed by cast polymerization of the fluid resin composition in the cell having the inner surface with the negative pattern corresponding to the surface fine structure subsequent to injecting the fluid resin composition into the cell.

3. The methacrylic resin molded article according to claim 1, wherein the composition is a casting material including said components A, B, and C, and wherein the surface fine structure is formed by polymerizing the casting material in the cavity defined by mold parts subsequent to filling the cavity with the casting material, at least one of the mold parts having the inner surface with the negative pattern corresponding to the surface fine structure.

4. The methacrylic resin molded article according to claim 1, wherein the polymerization initiator is a radical polymerization initiator.

5. The methacrylic resin molded article according to claim 1, wherein the polymerization initiator is a photopolymerization initiator.

6. The methacrylic resin molded article according to claim 1, further characterized by a coating layer adsorbed on the surface layer of the methacrylic resin molded article.

7. The methacrylic resin molded article according to claim 1, wherein the surface fine structure is an antireflection structure including conical projections each having an aspect ratio of not less than 1, the conical projections being two dimensionally arranged with a pitch ranged from 150 to 300 nm.

8. The methacrylic resin molded article according to claim 1, wherein the surface fine structure is a polarized light separating structure or a polarized light converting structure including elongated projections each having a rectangular cross section and an aspect ratio of not less than 2, the projections being arranged in parallel to each other with a pitch ranged from 300 to 500 nm.

9. The methacrylic resin molded article according to claim 1, wherein the surface fine structure has a pattern transfer fidelity of not less than 99% with respect to the negative pattern.

10. A process for producing a methacrylic resin molded article having a surface fine structure, the process comprising:
introducing a composition to a cell or cavity having an inner surface with a negative pattern corresponding to the surface fine structure, the composition including:
(A) 30 to 60 parts by weight of an unsaturated monomer mixture, which mixture contains 20 to 90% by weight of an unsaturated monomer including methylmethacrylate as a major component, and 10 to 80% by weight of an unsaturated monomer having at least two polymerizable double bonds in one molecule;
(B) 40 to 70 parts by weight of particles made of a polymer of an unsaturated monomer including methylmethacrylate as a major component, which particles include 20 to 100% by weight of partially crosslinked polymer particles and 0 to 80% by weight of non-crosslinked polymer particles; and
(C) 0.1 to 5 parts by weight of a polymerization initiator per 100 parts by weight of the total of the above components A and B, and
polymerizing the composition in the cell or cavity.

11. The process according to claim 10, wherein the composition is a fluid resin composition including said components A, B, and C, and said introducing includes injecting the fluid resin composition to the cell having the inner surface with the negative pattern corresponding to the surface fine structure, and wherein the fluid resin composition is polymerized in the cell.

12. The process according to claim 11, wherein the cell is a conveyer belt type continuous cell.

13. The process according to claim 10, wherein the composition is a fluid resin composition including said components A, B, and C, the process further comprising:
storing the fluid resin composition in a container to prepare a semisolid casting material within the container, prior to said introducing, wherein said introducing includes filling the cavity having the inner surface with the negative pattern corresponding to the surface fine structure, with the semisolid casting material, and wherein the semisolid casting material is polymerized in the cavity.

14. The process according to claim 13, wherein said filling includes compressing the semisolid casting material with a compression molding machine.

15. The process according to claim 13, wherein said filling includes injecting the semisolid casting material into the cavity with an injection molding machine.

16. The process according to claim 10, wherein the polymerization initiator is a radical polymerization initiator and said polymerizing includes heating.

17. The process according to claim 10, wherein the polymerization initiator is a photopolymerization initiator and said polymerizing includes irradiating with ultraviolet rays.

18. The process according to claim 10, further comprising maturing the composition to promote mixing of the resin composition, prior to said polymerizing.

19. The process according to claim 10, further comprising forming a layer of a fluid coating composition on the negative pattern prior to said polymerizing, wherein said polymerizing includes polymerizing the coating composition and the composition simultaneously in the cell or cavity.

20. The process according to claim 13, further comprising forming a layer of a fluid coating composition on the negative pattern prior to said polymerizing, wherein said polymerizing includes polymerizing the coating composition and the semisolid casting material simultaneously in the cavity.

21. The process according to claim 10, further comprising:
producing a master having a fine structure identical to the surface fine structure; and
producing a stamper mold for forming the fine structure, wherein said producing the master includes applying a resist on the surface of a substrate to draw the same pattern as the fine structure, developing the pattern of the resist to form a mask, and etching a base material using the mask to prepare the master, wherein said producing the stamper mold includes electrocasting using the master and separating a resultant object obtained by the electrocasting from the master to prepare the stamper mold, and wherein the stamper mold is used as the negative pattern.

22. The process according to claim 10, further comprising:
producing a master having the fine structure; and
producing the negative pattern, wherein said producing the master includes applying a resist on the surface of a substrate to draw the same pattern as the fine structure, developing the pattern of the resist to form a master, and etching a base material using the mask to prepare the master, and wherein said producing the negative pattern includes abutting the fine structure surface of the master and a transmitting plate, injecting an ultraviolet ray curable resin between the fine structure surface of the master and the transmitting plate, and hardening the ultraviolet ray curable resin on the transmitting plate by irradiating with ultraviolet rays which transmit the transmitting plate.

23. The process according to claim 21, wherein the surface fine structure of the master is an antireflection structure including conical projections each having an aspect ratio of not less than 1, the conical projections being two dimensionally arranged with a pitch of from 150 to 300 nm.

24. The process according to claim 21, wherein the surface fine structure of the master is a polarized light separating structure or a polarized light converting structure including elongated projections each having a rectangular cross section and an aspect ratio of not less than 2, the elongated projections being arranged in parallel to each other with a pitch of from 300 to 500 nm.

25. The process according to claim 22, wherein the surface fine structure of the master is an antireflection structure including conical projections each having an aspect ratio of not less than 1, the conical projections being two dimensionally arranged with a pitch of from 150 to 300 nm.

26. The process according to claim 22, wherein the surface fine structure of the master is a polarized light separating structure or a polarized light converting structure including elongated projections each having a rectangular cross section and an aspect ratio of not less than 2, the elongated projections being arranged in parallel to each other with a pitch of from 300 to 500 nm.
